(19) United States
(12) Patent Application Publication
(10) Pub. No.: US 2012/0025902 A1
(43) Pub. Date: Feb. 2, 2012

(54) ELECTRONIC DEVICE WITH POWER SAVING FUNCTION AND OPERATING METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/955,907

(22) Filed: Nov. 30, 2010

(30) Foreign Application Priority Data
Jul. 29, 2010 (TW) 99125203

(51) Int. Cl. G05F 1/10

(52) U.S. Cl. 327/544

(57) ABSTRACT

In an electronic device with power saving function, when the power saving function of the electronic device is active, the electronic device detects the distance between any object in a proximal area of the electronic device and the electronic device and stores the detected distance as an original distance, and then periodically detects the distance between the object and the electronic device, and stores the detected distance as a current distance. The electronic device is put into power saving mode if an difference between the original distance and the current distance does not fall into the predetermined range.

### RELATED APPLICATIONS

The subject matter disclosed in this application is related to subject matter disclosed in copending application entitled, “ELECTRONIC DEVICE WITH POWER SAVING FUNCTION AND OPERATING METHOD THEREOF”, filed ______ (Atty. Docket No. US33257), and assigned to the same assignee as named herein.

### BACKGROUND

1. Technical Field

The present disclosure relates to an electronic device with power saving function and an operating method thereof.

2. Description of Related Art

Power saving solutions for portable electronic devices often adopt standby or sleep states. However, when a portable electronic apparatus is operated for a period of time with no input received, such as during audio or video playback, such power-saving modes may be implemented in spite of the current operation, and the audio or video playback interrupted, inconveniencing the user.

Thus what is called for is an electronic device with power saving function and operating method thereof that can overcome the limitations described.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram of an electronic device with power saving function in accordance with an exemplary embodiment.

FIG. 2 is a block diagram of the electronic device 1 of FIG. 1.

FIG. 3 is a flowchart of a power-saving mode implementation method for the electronic apparatus of FIG. 1 in accordance of a first exemplary embodiment.

FIG. 4 is a flowchart of a power-saving mode implementation method for the electronic apparatus of FIG. 1 in accordance of a second exemplary embodiment.

FIG. 5 is a flowchart of a power-saving mode recovery method for the electronic apparatus of FIG. 1.

### DETAILED DESCRIPTION

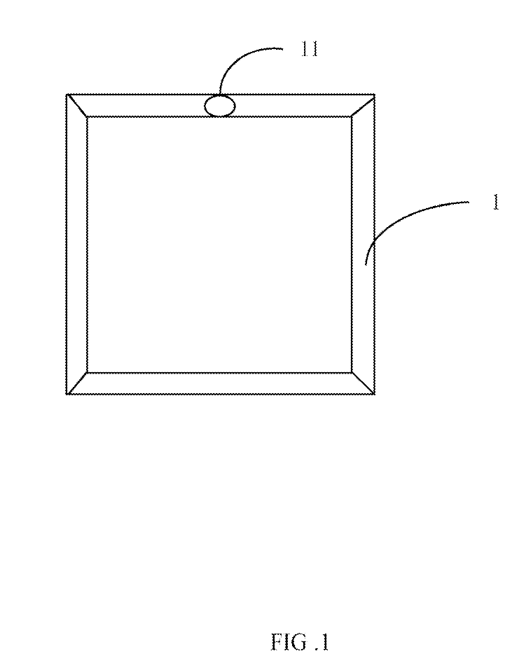

FIG. 1 is a schematic diagram of an electronic device 1 with power saving function (hereinafter “the electronic device”) in accordance with an exemplary embodiment. The electronic device 1 can be, for example, an e-book or a computer. When the power saving function of the electronic device 1 is enabled, and if no user is detected in proximity of the electronic device 1, a power saving mode, such as standby or sleep state, is implemented. When the electronic device 1 is in the power saving mode, no power is provided to selected components. The electronic device 1 includes a distance measurement unit 11. The distance measurement unit 11 measures distance between the electronic device 1 and any object in a proximal area of the electronic device. In this exemplary embodiment, the distance measurement unit 11 can be an infrared distance detector with detection angle set by a user.

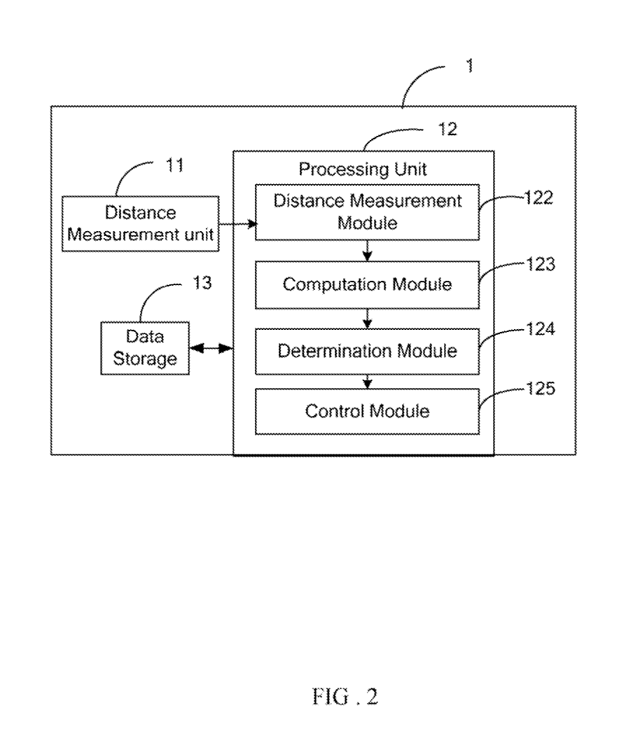

FIG. 2 is a block diagram of the electronic device 1 of FIG. 1. The electronic device 1 further includes a processing unit 12, a data storage 13 and other necessary components (not shown). The processing unit 12 includes a distance measurement module 122, a computation module 123, a determination module 124, and a control module 125.

Once power saving function of the electronic device 1 is enabled, the distance measurement module 122 directs the distance measurement unit 11 to detect distance between the electronic device 1 and any object in a proximal area of the electronic device 1, and records the distance as an original distance to the data storage 13. The distance measurement module 123 periodically detects a distance between the object and the electronic device 1, and stores the distance as a current distance to the data storage 13 after the original distance is determined. If there is no object in the proximal area of the electronic device 1, the measured distance is registered as infinite.

The computation module 123 is configured for computing a difference between the original distance and the current distance. The determination module 124 determines whether the difference between the original distance and the current distance falls within a predetermined range. If the difference between the original distance and the current distance does not fall into the predetermined range, the control module 125 puts the electronic device 1 into power saving mode. If the difference between the original distance and the current distance falls within the predetermined range, the current distance replaces the original distance stored in the data storage 11. The predetermined range can be predefined by user input.

When the electronic device 1 is in operation, a standard distance range between the electronic device 1 and the object in a proximal area of the electronic device 1 is generated. For example, if the standard distance range for the computer is 0-100 cm, and the standard distance range for e-book is 0-50 cm, the distance between the object and the electronic device 1 falls within the standard distance range and it is assumed that a user is operating or will operate the electronic device 1, and, conversely, if the distance between the object and the electronic device 1 does not fall into the standard distance range, it is ascertained that no user is present.

In another embodiment, if the difference between the original distance and the current distance falls within the predetermined range, the determination module 124 further determines whether the current distance falls within the standard distance range. If the current distance does not fall into the standard distance, the electronic device 1 is put into power saving mode. If the current distance falls within the standard distance range, the computation module 123 takes the current distance as the original distance and the distance measurement module 122 continues obtaining current distance measurements.

Once the electronic device 1 is in the power-saving mode, the distance measurement module 122 detects the distance between the object and the electronic device 1. The predetermined module 124 determines whether the distance falls within the standard distance range. If the distance falls within the standard distance range, the control module 125 restores the electronic device 1 from the power saving mode.

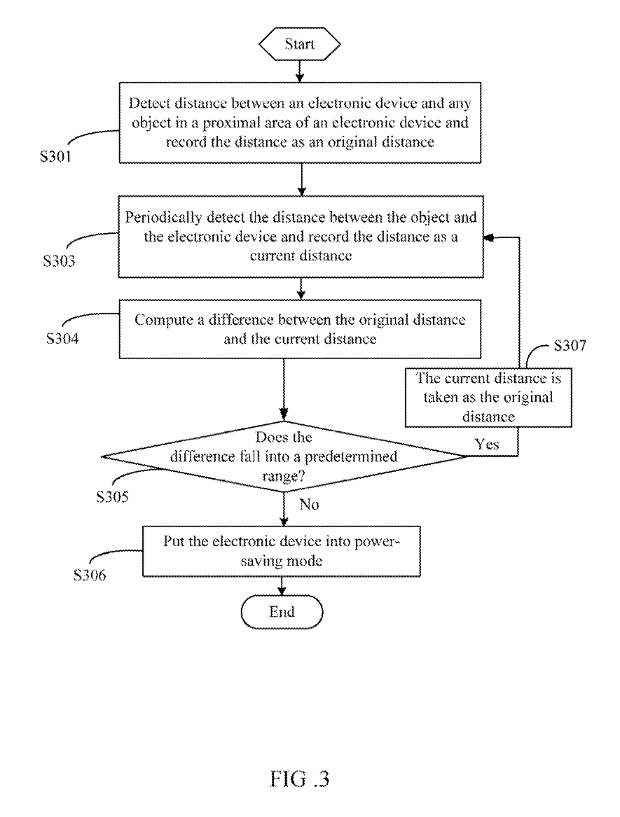

FIG. 3 is a flowchart of power-saving mode implementation method for the electronic apparatus of FIG. 1 in accordance of a first exemplary embodiment. In step S301, the distance measurement module 122 directs the distance measurement unit 11 to obtain the distance between the electronic device 1 and any object in a proximal area of the electronic device 1, and stores the distance as an original distance to the data storage 13.

In step S303, the distance measurement module 123 periodically detects the distance between the object and the electronic device 1, and stores the distance as a current distance to the data storage 13.

In step S304, the computation module 123 computes the difference between the original distance and the current distance.

In step S305, the determination module 124 determines whether the difference between the original distance and the current distance falls within the predetermined range.

If the difference between the original distance and the current distance does not fall into the predetermined range, in step S306 the control module 125 puts the electronic device 1 into power-saving mode.

If the difference between the original distance and the current distance falls within the predetermined range, in step S307, the current distance is taken as the original distance, and step S303 is implemented.

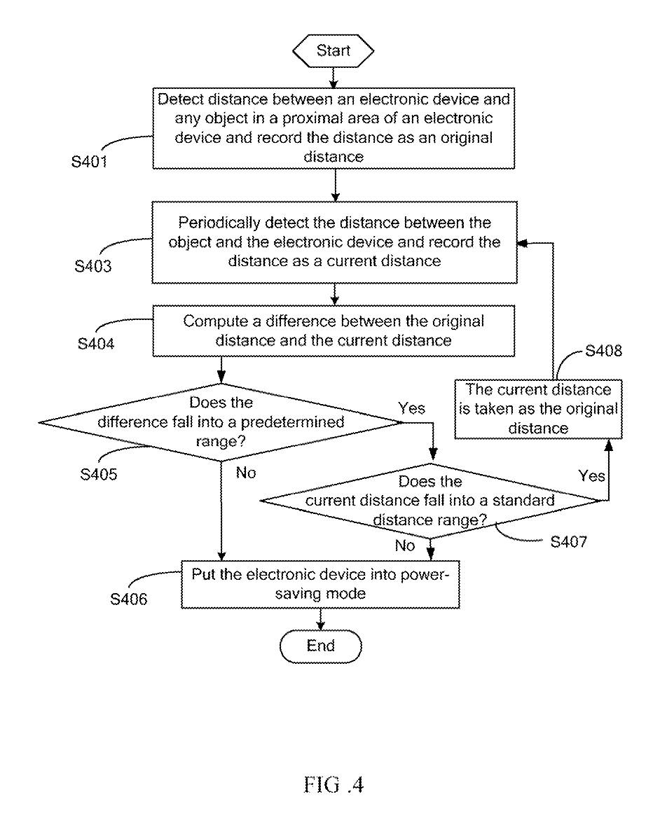

FIG. 4 is a flowchart of power-saving mode implementation method for the electronic apparatus of FIG. 1 in accordance of a second exemplary embodiment. In step S401, the distance measurement module 122 directs the distance measurement unit 11 to obtain the distance between the electronic device 1 and any object in a proximal area of the electronic device 1, and stores the distance as an original distance to the data storage 13.

In step S403, the distance measurement module 123 periodically detects the distance between the object and the electronic device 1, and stores the distance as a current distance to the data storage 13.

In step S404, the computation module 123 computes the difference between the original distance and the current distance.

In step S405, the determination module 124 determines whether the difference between the original distance and the current distance falls within the predetermined range.

If the difference between the original distance and the current distance does not fall into the predetermined range, in step S406 the control module 125 puts the electronic device 1 into power-saving mode.

If the difference between the original distance and the current distance falls within the predetermined range, in step S 407, the determination module 124 further determines whether the current distance falls within the standard distance range.

If the current distance does not fall into the standard distance, step S406 is implemented.

If the current distance falls into to the standard distance, in step S408, the current distance is taken as the original distance, and step S403 is implemented.

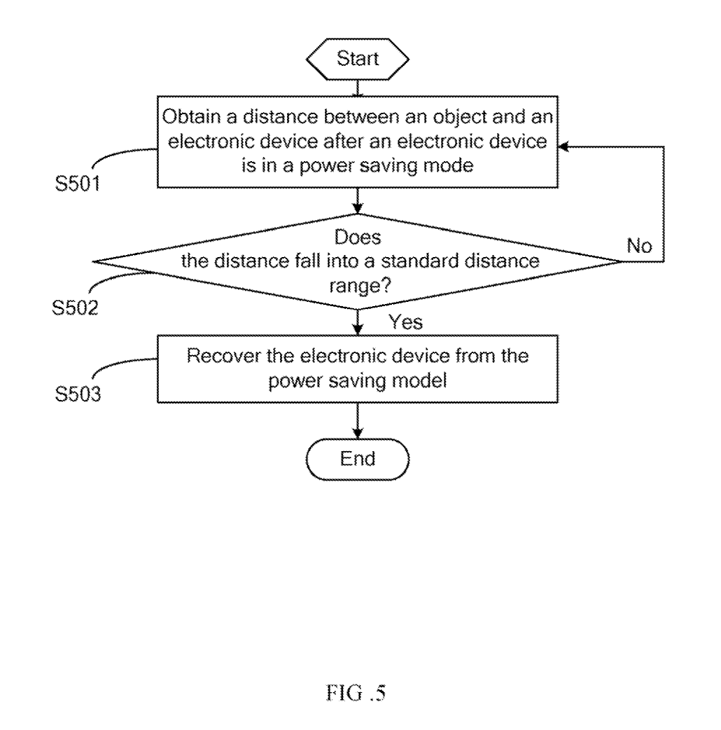

FIG. 5 is a flowchart of power-saving mode recovery method for the electronic apparatus of FIG. 1. In step S501, once electronic device 1 is in power-saving mode, the distance measurement module 122 periodically detects the distance between the object and the electronic device 1.

In step S502, the predetermined module 124 determines whether the distance falls within the standard distance range. If the distance does not fall within the standard distance range, step S 501 is implemented.

If the distance falls within the standard distance range, in step S503, the control module 125 recovers the electronic device 1 from the power saving mode.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with power saving function, comprising:
a distance measurement unit to detect distance between the electronic device and a proximal area of the electronic device;
a distance measurement module to obtain the distance detected by the distance measurement unit, and store the detected distance as an original distance once power saving function of the electronic device is enabled, and periodically obtain a distance between the object in the proximal area of the electronic device and the electronic device, and store the detected distance as a current distance after the original distance is determined;
a computation module to compute a difference between the original distance and the current distance;
a determination module to determine whether the difference between the original distance and the current distance falls within a predetermined range, if the difference between the original distance and the current distance falls within the predetermined range, the current distance is taken as the original distance;
a control module to control the electronic device to be into the power saving mode if the difference between the original distance and the current distance does not fall into the predetermined range.

2. The electronic device as described in claim 1, wherein if the difference between the original distance and the current distance falls within the predetermined range, the determination module further determines whether the current distance falls within a standard distance range, if the current distance does not fall into the standard distance range, the electronic device is put into power saving mode, if the current distance falls within the standard distance range, the computation module takes the current distance as the original distance.

3. The electronic device as described in claim 1, wherein once electronic device is in a power-saving mode, the distance measurement module periodically detects the distance between the object in the proximal area and the electronic device, the predetermined module determines whether the distance falls within the standard distance range, if the distance falls within the standard distance range, the control module recovers the electronic device from the power saving mode.

4. The electronic device as described in claim 1, wherein the distance measurement unit is an infrared distance detector.

5. The electronic device as described in claim 1, wherein the infrared distance detector has a detection angle, the detection angle is set by a user.

6. A method implemented by an electronic device with power saving function, comprising:
detecting the distance between any object in a proximal area of the electronic device and the electronic device through a distance measurement unit, and recording the detected distance as an original distance once power saving function of the electronic device is active;
periodically detecting the distance between the object in the proximal area of the electronic device and the electronic device through the distance measurement unit, and recording the detected distance as a current distance;
computing the difference between the original distance and the current distance;
determining whether the difference between the original distance and the current distance falls within a predetermined range, if the difference between the original distance and the current distance falls within the predetermined range, the current distance is taken as the original distance;
controlling the electronic device to be into the power saving mode if the difference between the original distance and the current distance does not fall into the predetermined range.

7. The method as described in claim 6, further comprising:
determining whether the current distance falls within a standard distance range if the difference between the original distance and the current distance falls within the predetermined range;
controlling the electronic device to be into the power saving mode if the current distance does not fall into the standard distance rang;
taking the current distance as the original distance, if the current distance falls within the standard distance range.

8. The method as described in claim 6, further comprising:
obtaining the distance between the object in a proximal area of the electronic device and the electronic device according to the distance detected by the distance measurement unit;
determining whether the distance falls within a standard distance range;
recovering the electronic device from the power saving model if the distance falls within the standard distance range.
